(19) United States
(12) Patent Application Publication
(10) Pub. No.: US 2013/0295869 A1
(43) Pub. Date: Nov. 7, 2013

(54) SQUARE LAW EXTENSION TECHNIQUE FOR HIGH SPEED RADIO DETECTION

(71) Applicant: MICROSEMI CORPORATION, Aliso Viejo, CA (US)

(72) Inventors: Alan D. Kendall, El Dorado Hills, CA (US); John H. Merriner, El Dorado Hills, CA (US)

(73) Assignee: MICROSEMI CORPORATION, Aliso Viejo, CA (US)

(21) Appl. No.: 13/860,875

(22) Filed: Apr. 11, 2013

Related U.S. Application Data
(60) Provisional application No. 61/641,213, filed on May 1, 2012.

(51) Int. Cl. H04B 1/10

(52) U.S. Cl. CPC H04B 1/10
USPC 455/311

(57) ABSTRACT

A square law extension circuit is disclosed that operates over a range of frequencies and power levels. The square law extension circuit includes a detector, an amplifier, and an expander. The detector has an input for receiving radio frequency (RF) signals and providing a detected signal output. The amplifier has an input that receives the detected signal output of the detector and provides an output for an amplified detected signal. The expander has an input that receives the amplified detected signal and is arranged to provide an expanded signal output. The expanded signal output is a signal that increases in a first proportion to the amplified detected signal up to a predetermined threshold and increases at a second proportion to the amplified detected signal that is more than the first proportion when the expanded signal output exceeds the predetermined threshold.

### CROSS REFERENCE TO RELATED APPLICATIONS

This application claims the benefit of commonly-owned copending U.S. provisional patent application Ser. No. 61/641,213, filed May 1, 2012, herein incorporated by reference.

### FIELD OF THE INVENTION

This disclosure relates to radio signal power detection. More specifically, the disclosure relates to the accurate measurement of instantaneous power in high density signal environments to recover lower power signals.

### BACKGROUND OF THE INVENTION

Square law detection is commonly employed to accurately measure the instantaneous power level of environments with multiple radio frequency (RF) signals. Conventional radio signal detection circuits are used to detect these RF signals and have small signal semiconductor diodes to demodulate amplitude-modulated and pulse-modulated RF signals in such multiple signal environments. However, the ability to measure two or more signals at widely different power levels in a multiple signal environment is limited. The ability to measure two or more signals at different power levels is also known as the instantaneous dynamic range of square law detection circuits. The absolute dynamic range of this process is limited by thermal noise at low power levels and breakdown at high power levels. The behavior of the ability to accurately measure two or more signals at widely different power levels changes considerably between these ultimate limits.

At low signal power levels, diode detectors demonstrate a “square-law” conversion in which the change in the detected output voltage is proportional to the change in RF input signal power of the detection circuit. The behavior of the signal at low power levels is generally referred to as the “square law” region. At high signal power levels, diode detectors demonstrate behavior consistent with rectification in which the change in the detected output voltage is proportional to the change in RF input signal voltage of the detection circuit. The rectification behavior is generally referred to as the “linear” or “linear-law” region. The change in the behavior of the ability to measure two or more signals at different power levels causes distortion in the detected output if the detector circuit is operated in the transition between the square law and linear law region or is operated across both regions.

Many of the known detector circuits combine a detector and an amplifier to enhance the linear region of the circuit and are used to recover information from amplitude modulated RF signals. These linear extension circuits enhance the operation of the circuit over a range of temperature and input signal levels and are described in U.S. Pat. No. 4,490,681 to Turner, U.S. Pat. No. 4,502,015 to Nicolas, et al., U.S. Pat. No. 5,873,029 to Grondahl, et al., among other references. Some square law extension circuits are known, such as U.S. Pat. No. 3,241,079 to Snell, but these techniques do not address increasing the ability to accurately measure low level signals in the presence of large signals in a high density or multiple signal environment. Such known square law extension circuits cannot accurately detect low level signals when a large signal biases the parallel set of diodes in the linear region of the signal.

Improved methods of correcting the distortion of high modulation rate signals in multiple signal environments using analog techniques would be desired in the art.

### SUMMARY OF THE INVENTION

An object of this invention is to provide methods and device structures suitable for accurately measuring instantaneous power in high density signal environments to facilitate the recovery of lower power signals that may otherwise be suppressed as the detector circuit enters the linear region from the square law region of the detector circuit's output. High density signal environments include multiple signals that can range over a wide range of power levels.

The foregoing and other objects, features and advantages of the invention will become more readily apparent from the following detailed description of embodiments of the invention which proceeds with reference to the accompanying drawings.

### BRIEF DESCRIPTION OF THE DRAWINGS

FIG. 1 is a block diagram that corresponds to elements of a square law extension circuit, according to embodiments of the disclosure.

FIG. 2 is a schematic of an example square law extension circuit in accordance with aspects of the disclosure.

FIG. 3 is a graphical representation of an output versus the RF input signal for corrected and uncorrected detector circuits, according to aspects of the disclosure.

### DETAILED DESCRIPTION

In the drawings, which are not necessarily to scale, like or corresponding elements of the disclosed systems and methods are denoted by the same reference numerals.

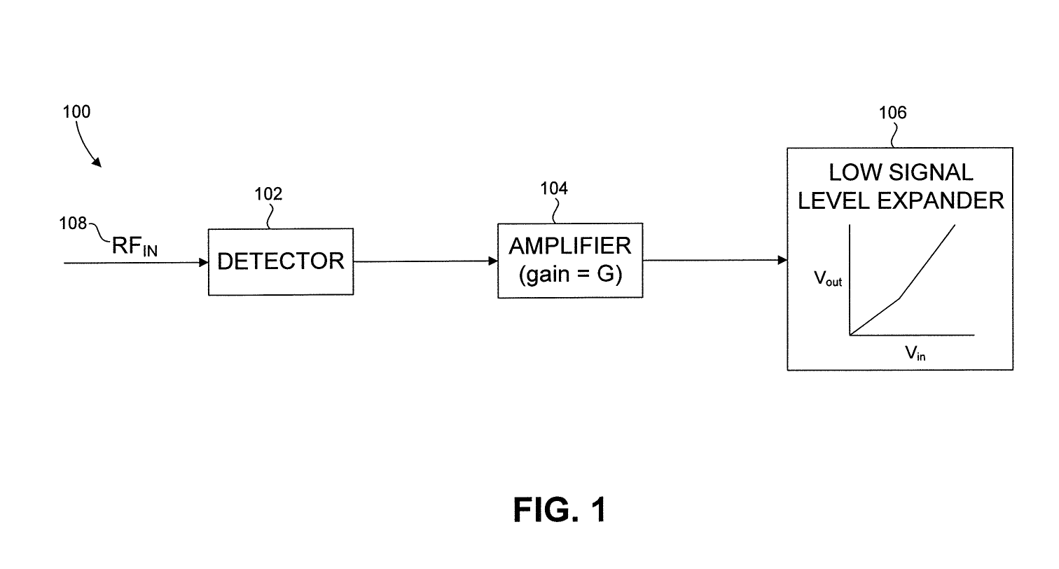

Accurate analog measurement of instantaneous power in high density signal environments facilitates the recovery of lower power signals, specifically lower power pulsed signals for example, that would otherwise be suppressed as the detected signals enter the linear region from the square law region. A block diagram of a square law extension circuit 100 is shown in FIG. 1, which includes a detector 102 that is coupled to an amplifier 104. The output of the amplifier 104 is fed to a voltage dependent attenuator or expander 106 that expands the gain of the amplifier 104 coincidentally with the signal compression that occurs as the detector 102 transitions from a square law region into a linear law or rectification region. The detector 102 includes any conventional detector circuit and detects voltages of incoming RF signals 108 in a multiple signal environment in which the input power signal levels can span multiple orders of magnitude. The detector 102 is coupled to the amplifier 104 by a direct connection in the example shown in FIG. 1. The amplifier 104 may be a high-speed, low-noise DC-coupled amplifier or any other suitable amplifier.

The expander 106 shown in FIG. 1 is a low signal level expander that can be depicted by a graph representing the output signal voltage (Vₒᵤₜ) versus the input voltage (Vᵢₙ). The Vₒᵤₜ increases proportionately to the Vᵢₙ of the expander while the detector signal's power level is relatively low and thus in the square law region. When the signal's power level becomes relatively high and thus transitions from the square law region to the linear region, the Vₒᵤₜ slope gradually increases to approximate a continued square law transfer function. In some example square law extension circuits, an additional 20 decibels (dBm) of square law operation may be realized.

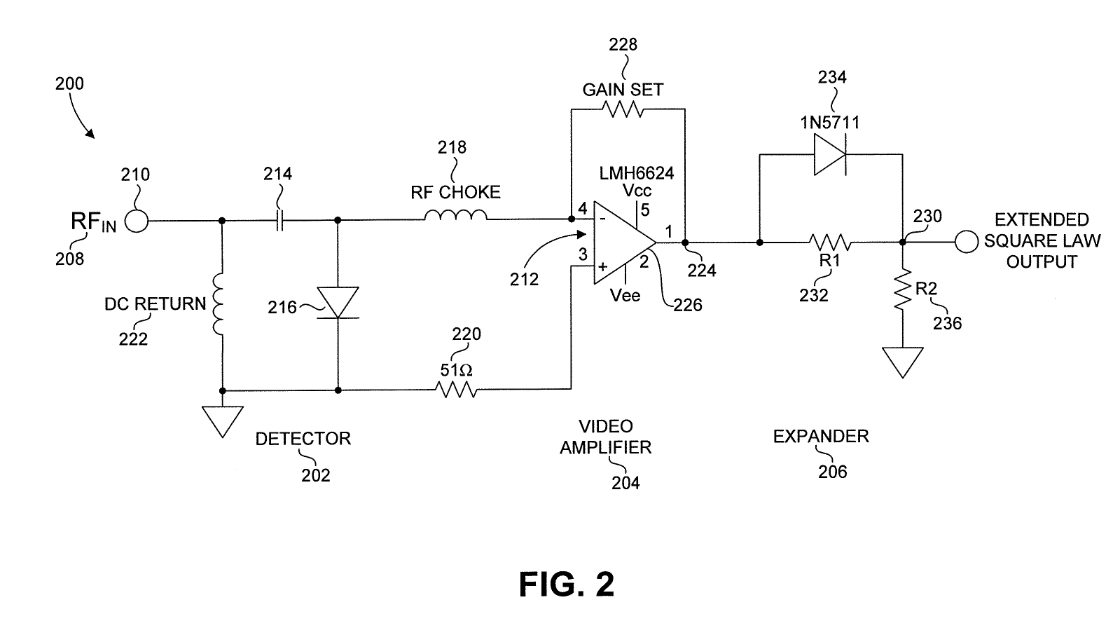

The square law extension circuit 100 shown in FIG. 1 operates over a wide range of frequencies and power levels, e.g., multiple orders of magnitude. The detector 102 of the square law extension circuit 100 has an input for receiving RF signals 108 in the multiple signal environment. The detector 102 then provides a detected signal output, which can be in part or entirely based on the received RF signal 108. The amplifier 104 shown in FIG. 1 can be, for example, a video amplifier or another suitable amplifier that has an input that receives the detected signal output from the detector 102 and provides an output for an amplified detected signal. The amplified detected signal can be based at least in part on an amplification of the detected signal output. The expander 106 shown in FIG. 1 has an input that receives the amplified detected signal from the video amplifier 104 and is arranged to provide an expanded signal output that can be based at least in part on the received amplified detected signal. The expanded signal output is a signal that increases in a first proportion to the amplified detected signal up to a predetermined threshold and increases at a second proportion to the amplified detected signal when the expanded signal output exceeds the predetermined threshold. The second proportion is greater than the first proportion in some examples. The first proportion can indicate or track square law behavior of the expanded signal output and, above the threshold, the second proportion corrects for a deviation from square law behavior of the expanded signal output. The expanded signal output may increase linearly with respect to the detected signal output up to the predetermined threshold. The predetermined threshold may be any suitable threshold and will be discussed in greater detail below in reference to FIG. 2.

FIG. 2 is a schematic of specific example of a square law extension circuit. This exemplary square law extension circuit 200 includes a detector 202, a video amplifier 204, and an expander 206. In some embodiments, the RF signals 208 applied to the detector 202 operate in a frequency range between 1 mega Hertz (MHz) and 100 giga Hertz (GHz) with appropriate component values, although the frequency range may be expanded or narrowed as desired. The detected signal output of the detector 202 may include a power range that is at least 2 orders of magnitude, for example. The expanded output power associated with the expanded signal output extends over a range of at least 4 orders of magnitude in some examples and again this range can be expanded or narrowed as desired by selecting components of particular values in the square law extension circuit 200.

The predetermined threshold described above in reference to FIG. 1 may be associated with an expanded signal output having a voltage of approximately 0.4 volts (V), although this value may be varied, depending on the values of the selected components shown in the schematic of the square law extension circuit 200 in FIG. 2. In this example, the expander 206 caps the signal levels when the voltage of the expanded signal output reaches approximately 0.4V, or any other set threshold value.

The square law extension circuit 200 shown in FIG. 2 includes a detector 202, a video amplifier 204, and an expander 206, as discussed above. The detector 202 has an input 210 for receiving the RF signals 208 and provides an output 212, which is the input to the amplifier 204. The detector 202 in this example square law extension circuit 200 includes a capacitor 214, a detector diode 216, an RF choke 218, and a 51Ω resistor 220, as shown in FIG. 2. The capacitor 214 and the RF choke 218 are electrically connected in series with each other while the detector diode 216 and a DC return inductor 222 are in parallel with each other. The resistor 220 is electrically coupled in parallel with the RF choke 218 in this example. The detector diode 216 may be a Schottky diode, a tunnel diode, or any other suitable diode. An example detector diode 216 may be the 1N5711 diode manufactured by Microsemi®.

The output of the detector is the RF signal output 212 and is a voltage that is then input into the video amplifier 204. The video amplifier 204 provides an output 224 for an amplified detected RF signal. As shown in the example square law detection circuit 200 in FIG. 2, the amplifier 204 may include an operational amplifier 226, such as the LMH6624 amplifier manufactured by National®, and a gain set resistor 228 electrically coupled in parallel to each other. The gain set resistor 228 allows for the gain of the amplifier 204 to be varied in a conventional manner. In general, the gain is selected to boost the lowest power input signals for easy detection. An example gain is G=10.

The expander 206 shown in FIG. 2 has an input that receives the amplified detected RF signal from the output 224 of the amplifier 204 and provides an expanded signal output 230. In the example square law extension circuit 200 shown in FIG. 2, the expander 206 includes a first resistor (R₁) 232 and an expander diode 234 that is electrically connected in parallel with the R₁ 232 to node 230. A second resistor (R₂) 236 is electrically connected in series with the R₁ 232 and the expander diode 234 at node 230 and to ground. In this example, R₁ 232 and R₂ 236 form a voltage divider or a voltage attenuator that at least partially cancels the gain of the video amplifier 204 at relatively low RF power levels, i.e., the power of the RFᵢₙ 208 to the detector 202 is relatively low. The voltage divider reduces the expanded signal output proportionately equal to the gain that is necessary to correct for the square law deviation at higher input power levels. A voltage drop occurs across R₁ 232 and R₂ 236 in the voltage divider. The voltage drop across R₁ 232 increases to the threshold voltage discussed above (e.g., 0.4V) at which point the expander diode 234 begins to conduct current. The square law region of the detector signal can be extended by varying the threshold voltage at which the expander diode 234 begins to conduct current.

The parallel current paths of the expander diode 234 and R₁ 232 increase the voltage drop across R₂ 236. The expander diode 234 may include a Schottky diode in some examples. Further increases in RF power will cause the expander diode 234 to conduct more heavily and produce an exponential decrease in attenuation as the detector signal transitions from the square law region to the linear law region of the signal. Specifically, the voltage drop across the expander diode 234 is determined as follows: when the voltage drop across R₁ 232 is below the threshold voltage, the voltage drop across the expander diode 234 is: V_{expander diode}=I*R₁ or Vᵢₙ*R1/(R1+R2). When the voltage drop across R₁ reaches the threshold voltage of the expander diode 234, the voltage drop across the expander diode 234 and R₁ becomes fixed at the characteristic voltage drop of the expander diode 234 or the threshold voltage (V_{f(diode)}). As the current through the expander diode 234 increases, the voltage across R₂ continues to increase with the current: I=(Vᵢₙ−V_{f(diode)}*R₂.

The gain of the video amplifier 204 is set so that expander diode 234 begins to conduct current at the voltage level where the detector signal begins to deviate from square law behavior. As the RF power level that is applied to the detector 202 shown in FIG. 2 increases, the voltage drop across R₁ 232 increases until it reaches the threshold voltage. When the voltage drop across R₁ 232 reaches the threshold voltage, the expander diode 234 receives current and the voltage drop across R₁ 232 remains at the threshold voltage while a voltage drop across R₂ 236 begins to increase. The output at node 230 of the expander 206 may terminate in a high-impedance device so that essentially no current flows through that expanded square law output node and that all of the current flows through R₂ 236.

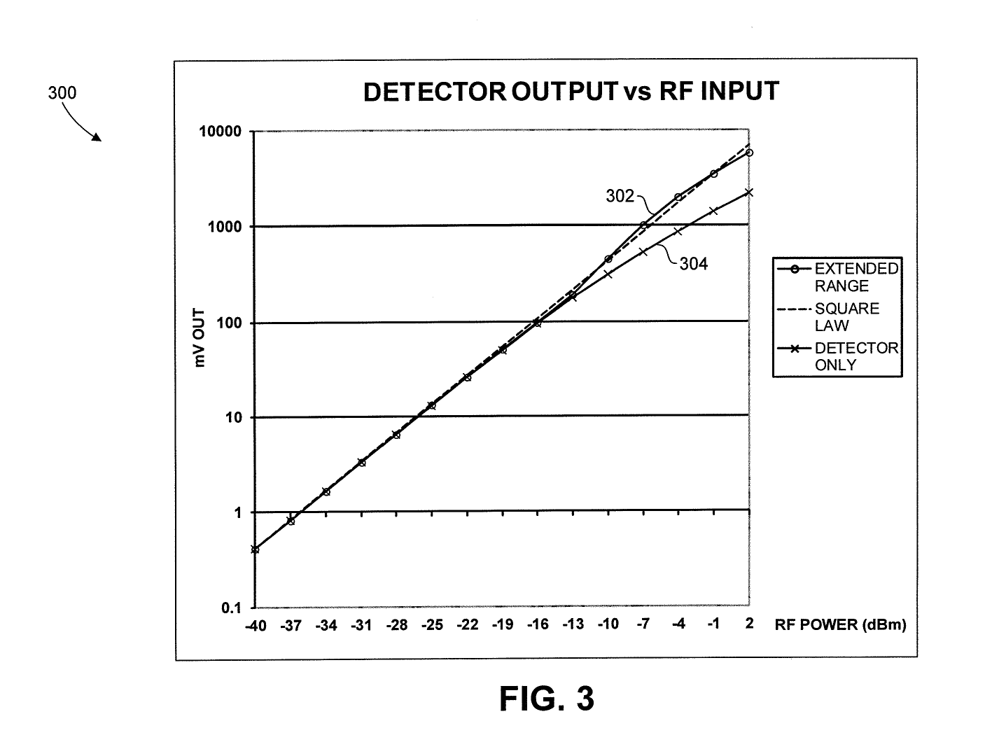

FIG. 3 is a graphical representation 300 of a detector circuit's output versus the RF input for corrected 302 and uncorrected 304 detector circuits. By employing the square law extension circuit discussed above with reference to FIGS. 1 and 2, the square law region of the detector circuit's output may be extended over a broader power range than the detector alone provides. Without the square law extension circuit, the output signal 304 of the detector circuit alone begins to deviate from square law behavior at approximately −22 dBm in the example shown in FIG. 3, while the output signal 302 from the square law detection circuit begins to deviate from square law behavior at approximately −1 dBm. In this example, the threshold is set to begin correction at about −13 dBm.

Methods implementing the above square law detection circuit also measure power in a multiple RF signal environment over a wide range of frequencies and power levels. Such methods can detect RF power in a multiple RF signal environment, amplify the detected voltage output of the RF power to create an amplified voltage output having a predetermined gain, and expand the amplified voltage output by causing an expanded output signal to increase in a first proportion to the amplified voltage output up to a predetermined threshold and increase at a second proportion to the amplified voltage output that is more than the first proportion when the expanded output signal exceeds the predetermined threshold. The multiple signal environment can include signals at different frequencies and power levels. In some examples, one signal has a power level that is greater than a second signal and the power levels between the two signals may differ by at least 2 orders of magnitude. In other examples, the power levels of the various signals may differ by the entire detected range. Any of the signals may be a pulsed signal. In some examples, the detected signal with a lower power level is a pulsed signal.

Having described and illustrated the principles of the invention in a preferred embodiment thereof, it should be apparent that the invention can be modified in arrangement and detail without departing from such principles. We claim all modifications and variations coming within the spirit and scope of the following claims.

1. A square law extension circuit operating over a range of frequencies and power levels, comprising:
a detector having an input for receiving radio frequency (RF) signals and providing a detected signal output;
an amplifier having an input that receives the detected signal output and providing an output for an amplified detected signal; and
an expander having an input that receives the amplified detected signal and is arranged to provide an expanded signal output, wherein the expanded signal output is a signal that increases in a first proportion to the amplified detected signal up to a predetermined threshold and increases at a second proportion to the amplified detected signal that is more than the first proportion when the expanded signal output exceeds the predetermined threshold.

2. The square law extension circuit of claim 1, wherein the expanded signal output increases linearly with respect to the detected signal output up to the predetermined threshold.

3. The square law extension circuit of claim 1, wherein the first proportion indicates square law behavior of the expanded signal output and the second proportion corrects for a deviation from square law behavior of the expanded signal output.

4. The square law extension circuit of claim 1, wherein the RF signals applied to the detector operates in a frequency range between 1 MHz and 100 GHz.

5. The square law extension circuit of claim 1, wherein the detected signal output includes a power range of at least 2 orders of magnitude.

6. The square law extension circuit of claim 5, wherein an expanded output power associated with the expanded signal output extends over a range of at least 4 orders of magnitude.

7. The square law extension circuit of claim 1, wherein the expander includes a first resistor, a diode electrically connected in parallel with the first resistor, and a second resistor electrically connected in series with the first resistor and the diode, and wherein the first resistor and the second resistor form a voltage divider.

8. A method of measuring power in a multiple radio frequency signal environment over a wide range of frequencies and power levels, comprising:
detecting radio frequency power in the multiple radio frequency signal environment;
amplifying a detected voltage output of the radio frequency power to create an amplified voltage output having a predetermined gain;
expanding the amplified voltage output by causing an expanded output signal to increase in a first proportion to the amplified voltage output up to a predetermined threshold and increase at a second proportion to the amplified voltage output that is more than the first proportion when the expanded output signal exceeds the predetermined threshold.

9. The method of claim 8, wherein the multiple radio frequency environment includes a first signal having a first power level and a second signal having a second power level that is lower than the first power level.

10. The method of claim 9, wherein the second signal includes a pulsed signal.

11. The method of claim 9, wherein the second power level is lower than the first power level by at least 2 orders of magnitude.

12. The method of claim 8, wherein the first proportion indicates square law behavior of the expanded output signal and the second proportion indicates a correction for a deviation from square law behavior of the expanded output signal.

13. The method of claim 8, wherein amplifying a voltage output of the detected radio frequency power is performed by a high-speed, low-noise direct current coupled amplifier.

14. The method of claim 8, wherein the low level of the radio frequency power is defined at −13 dBm or less.

15. A square law extension circuit operating over a range of frequencies and power levels, comprising:
a detector having an input for receiving radio frequency (RF) signals and providing a detected RF signal output;
an amplifier having an input that receives the detected RF signal and providing an output for an amplified detected RF signal; and
an expander having an input that receives the amplified detected RF signal and providing an expanded signal output, wherein the expander includes a first resistor, a diode electrically connected in parallel with the first resistor, and a second resistor electrically connected in series with the first resistor and the diode, and wherein the first resistor and the second resistor form a voltage divider,
wherein increasing power applied to the detector input causes a voltage drop across the first resistor to increase, and wherein when a voltage drop across the first resistor reaches a first threshold voltage, the first diode receives current and the voltage drop across the first resistor remains at the first threshold voltage while a voltage drop across the second resistor increases.

16. The square law extension circuit of claim 15, wherein the power applied to the detector operates in a frequency range between 1 MHz and 100 GHz.

17. The square law extension circuit of claim 15, wherein the video amplifier defines a gain that is set so the diode starts conducting current when the detected output signal begins deviating from square law behavior.

18. The square law extension circuit of claim 15, wherein the voltage divider reduces the expanded signal output by a proportion equal to the gain necessary to correct for the square law deviation.

19. The square law extension circuit of claim 15, wherein the expander diode includes a Schottky diode.

20. The square law extension circuit of claim 15, wherein the first threshold voltage is approximately 0.4V.
